(19) United States
(12) Patent Application Publication
(10) Pub. No.: US 2026/0242129 A1
(43) Pub. Date: Aug. 20, 2026

(54) NOVEL NESTED TRASH BAG SYSTEM FEATURING FAST AND EASY BAG REPLACEMENT

(71) Applicant: Ace-silicon LLC, San Diego, CA (US)

(72) Inventor: Chengzhou Wang, San Diego, CA (US)

(21) Appl. No.: 19/055,323

(22) Filed: Feb. 17, 2025

(51) Int. Cl. B65F 1/06; B65F 1/16

(52) U.S. Cl. CPC B65F 1/065; B65F 1/062; B65F 1/067; B65F 1/068; B65F 1/16; B65F 2210/137; B65F 2210/167; B65F 2210/179; B65F 2210/1815

(57) ABSTRACT

Systems and method are disclosed for a nested trash bag system by: providing a receptacle having an open top end and a closed bottom end; inserting a plurality of trash bags nested within the receptacle, each trash bag having an open top end and a closed bottom end; removably attaching each trash bag to an adjacent trash bag; using an innermost trash bag; and removing the innermost trash bag from the receptacle, thereby automatically positioning a subsequent trash bag for use.

### BACKGROUND

In various settings, including homes, offices, and public spaces, the task of changing trash bags is a routine but labor-intensive activity. The conventional method of trash bag replacement requires a series of steps that are time-consuming and inconvenient. To replace a trash bag, one must first remove the full bag and dispose of it appropriately. Following this, a new trash bag must be retrieved, which is frequently stored in a separate location, adding an extra step. The replacement bag must then be opened, often requiring the user to shake or fill the bag with air to give it shape, and then positioned within the trash can. This process is further complicated by the need to adjust the bag to ensure it fits snugly, often involving squeezing out excess air to prevent the bag from collapsing into the trash can. These steps, while individually simple, add up to a repetitive and inconvenient routine that becomes particularly burdensome in high-traffic environments where trash bags need frequent replacement. In addition, improper installation of a trash bag can result in an uneven or untidy appearance, especially when the bag is folded over the edges of the receptacle to prevent slippage. This practice, while functional, detracts from the aesthetic appeal of the trash receptacle and the surrounding area.

Attempts to streamline the trash bag replacement process while maintaining aesthetic appearance have led to the development of smart trash receptacles, which are designed to automate certain aspects of waste management. Such systems often use electronic sensors to detect when the trash bag is full, automatically sealing the used bag and, in some cases, deploying a fresh bag into the receptacle. While these solutions provide a hands-free experience and reduce some of the manual steps, they come with significant drawbacks. Smart trash receptacles are generally complex in design, incorporating electronic components that drive up the initial cost. Moreover, many of these systems require proprietary or custom-sized bags, which add to the expense of using these products over time. As a result, while these devices offer convenience, they remain financially out of reach for many users and are not widely adopted in everyday settings.

Additionally, the dependence of smart trash receptacles on electronic components introduces reliability and maintenance concerns. These systems require power sources, whether batteries or a direct power connection, which increases maintenance needs and may cause functionality issues if the power supply is interrupted. The inclusion of moving parts and sensors also creates potential points of failure, making these products less durable and more likely to require repair or replacement than traditional trash cans. For many users, particularly those in environments with high trash volume or limited resources, the potential for system malfunctions and the need for ongoing maintenance make these smart receptacles impractical. Consequently, despite their innovative approach, they have not gained widespread traction among users who seek a straightforward, cost-effective solution for waste disposal.

### SUMMARY OF THE INVENTION

In one aspect, a nested trash bag system includes a receptacle including: a container having an open top end and a closed bottom end; and a bag retention system configured to maintain a trash bag assembly in a predetermined position; and a trash bag assembly comprising a plurality of trash bags nested within the receptacle, wherein: each trash bag is proximal to an adjacent trash bag with a predetermined air gap therebetween; each trash bag is removably attached to the bag assembly; and removal of an inner trash bag from the receptacle automatically positions a subsequent trash bag for use.

In a further aspect, a nested trash bag system includes a receptacle having an open top end and a closed bottom end; a plurality of trash bags nested within the receptacle, each trash bag having an open top end and a closed bottom end, wherein each trash bag is removably attached to an adjacent trash bag, and wherein removal of an innermost trash bag from the receptacle automatically positions a subsequent trash bag for use.

In another aspect, a method for manufacturing a trash bag assembly in a trash management system includes providing a plurality of trash bags, wherein the trash bag has a uniform shape, size, and thickness suitable for nesting one within another; inserting the first trash bag into a filler module, wherein the filler module is configured to securely position the first trash bag and facilitate the sequential insertion of additional trash bags; aligning the trash bags in a sequential arrangement such that each subsequent trash bag is positioned to be inserted into the preceding trash bag on a filler module; upon all trash bags in place, applying a controlled compression force to remove air between adjacent trash bags to create a nested configuration while maintaining an integrity and a shape of the trash bags; melting the top of the nested trash bags into one “header” piece using a binding mechanism to seal the trash bag assembly from air; pulling out the filler module from the trash bag assembly; flattening the trash bag assembly by squeezing out the air; perforating the flattened trash bag assembly right below the header to create a perforated strip or belt-like structure; cutting the uneven top of the header; and packaging the trash bag assembly in a protective material to prevent damage or contamination during handling and shipping.

In a further aspect, a method of using a nested trash bag system includes providing a receptacle having an open top end and a closed bottom end; inserting a plurality of trash bags nested within the receptacle, each trash bag having an open top end and a closed bottom end; using an innermost trash bag; and removing the innermost trash bag from the receptacle, thereby automatically positioning a subsequent trash bag for use.

In yet another aspect, a trash management system is disclosed that simplifies the bag replacement procedure while maintaining a tidy and visually appealing setup. The system includes a specially designed trash bag assembly and a receptacle configured to house it. The trash bag assembly features a nested stack of bags arranged tightly without air gaps, equipped with perforated zones for individual bag removal. The receptacle integrates a bag retention system, an optional compression mechanism, and an optional controllable airflow system, collectively working to streamline bag replacement, optimize bag fit, and preserve a neat exterior appearance.

In other aspects, methods are disclosed for both the efficient use and manufacturing of the trash bag assembly. Installation and removal methods include sequentially securing bags with the liner ring, activating airflow systems to expel air during bag installation, and facilitating easy separation and removal of filled bags. The manufacturing method ensures a tightly nested configuration, precise sealing, and a perforated header design of the bag assembly.

In implementations, the trash bag assembly utilizes a shared header that interacts with the receptacle's liner ring, securing the bags in place and ensuring an airtight seal between the bags and the receptacle interior. The liner ring also serves an aesthetic purpose, concealing the exposed portions of the trash bag assembly for a cleaner appearance. Additionally, the system optionally features a blow fan and a controllable airflow mechanism, including one-way valves and air compartments, to expel trapped air and ensure the bags conform closely to the receptacle's interior, enhancing stability and capacity utilization.

Advantages of the system may include one or more of the following. The system does not require complex electronics and requires minimal maintenance. This integrated approach offers a cost-effective, user-friendly solution that reduces manual effort, ensures optimal utilization of receptacle space, and provides a visually refined trash management system for residential or commercial use. The nested trash bag system is ideally suited for various environments including residential, commercial, and industrial settings, where the task of replacing trash bags can be repetitive and time-consuming. This system reduces the time and effort required for individuals to manage waste disposal, thereby improving sanitary conditions and facilitating maintenance routines. Additionally, the receptacle serves not only as a housing for the nested bags but also as the actual receptacle for the trash, thus effectively integrating the storage and functional elements of waste management into a single unified system. The removably attached nested trash bags within the receptacle provide users with a continuous supply of bags and eliminate the need to locate and install a new bag after each removal. This design ensures that there is always a fresh bag ready for use, minimizing contact with waste material and simplifying the process of trash disposal.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates one embodiment of a trash bag system.

FIGS. 2A-2B illustrate exemplary nested trash bags.

FIG. 3A illustrates exemplary liner rings without a fan while FIG. 3B illustrates exemplary liner rings with a fan.

FIG. 4A illustrates one embodiment with manual trash bag deployment while FIG. 4B illustrates an embodiment with powered air assisted trash bag deployment.

FIG. 5 illustrates an exemplary removal of a trash bag in accordance with the invention.

FIG. 6 illustrates an exemplary system for forming the nested trash bags.

FIG. 7 illustrates an exemplary routine for installing and removing the trash bag assembly in the trash management system, in accordance with one embodiment.

FIG. 8 illustrates an exemplary routine for manufacturing the trash bag assembly in the trash management system, in accordance with one embodiment.

### DETAILED DESCRIPTION

A trash management system is provided to simplify the process of replacing trash bags while maintaining a tidy and aesthetically appealing appearance. The system comprises two main components: a specially designed trash bag assembly and a corresponding container/receptacle. Together, these components enable efficient, user-friendly, and cost-effective waste management.

The trash bag assembly consists of a plurality of individual trash bags arranged in a nested stack configuration. Each bag is positioned entirely within the preceding bag in a closely compressed state, with substantially no air gaps between adjacent bags. This arrangement is facilitated by perforated zones or separation belts that allow for easy removal of individual bags without disturbing the remaining stack. The bags may feature drawstrings positioned below the perforation zones to facilitate secure sealing and convenient carrying after removal. In some embodiments, the bags are manufactured to have identical dimensions, while in others, the inner bags may be slightly smaller than the outer ones, depending on the chosen manufacturing process.

The receptacle is designed to house the trash bag assembly and incorporates several features to enhance functionality. A bag retention system, such as an adjustable liner ring, secures the trash bag assembly in place within the receptacle. The liner ring serves multiple purposes: it ensures a snug fit for the bag assembly, creates an airtight seal between the bag assembly and the receptacle's interior, and conceals the exposed portion of the bags for a polished exterior appearance. Additionally, the receptacle may include a compression system, such as a blow fan, to expel air trapped between the bag assembly and the interior walls during bag installation. This feature ensures that the bags conform closely to the receptacle's shape, optimizing stability and effective capacity.

An optional integrated airflow system enhances the system's functionality by managing air movement within the receptacle. The airflow system includes air inlets positioned at the bottom interior of the receptacle, an air compartment connected to the blow fan for channeling air, and an air outlet with a one-way valve. The one-way valve, which may be positioned at either the input or output of the blow fan, ensures unidirectional airflow from the interior to the exterior of the receptacle. This configuration maintains the trash bag assembly's adherence to the receptacle's interior walls and prevents external air from entering the receptacle.

The trash management system supports an efficient method for installing and removing trash bags. Users can position the bag assembly within the receptacle, secure it with the liner ring, and activate the airflow system to expel trapped air. When a bag is filled, it can be removed by tearing along the perforated zone, exposing the next bag in the stack for immediate use. This sequence eliminates the need for manual adjustments and streamlines the replacement process.

A manufacturing method is disclosed for the nested trash bag assembly. This method involves inserting individual bags sequentially into a filler module, compressing the bags to remove air, and binding the nested stack into a unified “header” using a heated binder. The assembly is then flattened, perforated below the header, and packaged for distribution. This manufacturing process ensures consistent quality and ease of use while maintaining the integrity of the bag assembly during shipping and handling.

By combining these features, the system addresses long-standing challenges in trash management, offering a system that is practical, economical, aesthetically appealing, and accessible for everyday use.

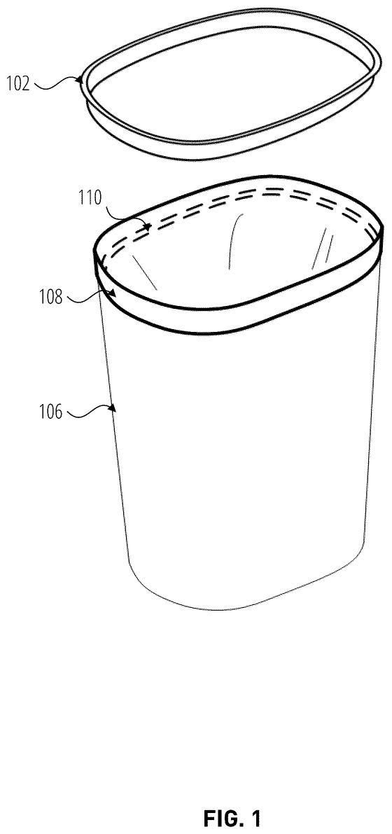

FIG. 1 illustrates one embodiment of a trash bag system. The system includes a trash receptacle 106 that receives a trash bag assembly 108 that is fitted over a neck 110. A liner ring 102 is fitted over the trash bag assembly 108 to secure the bags in the receptacle 106. In one embodiment, a specially designed trash bag assembly is provided that includes a nested stack of trash bags configured with perforations or separation zones for individual trash bag removal. A corresponding trash receptacle configured to house the trash bag assembly, the trash receptacle including: a bag retention system comprising adjustable supports or guides to maintain the trash bag assembly in a functional position, and an optional compression system configured to expel excess air between the trash bag assembly and the receptacle during bag placement, and an optional controllable airflow system to allow air to flow only from the interior to the exterior of the trash receptacle. The system is operable to simplify trash bag replacement by reducing manual handling, aligning subsequent trash bags automatically, and ensuring a secure fit within the trash receptacle. The plurality of trash bags (e.g., 20, 30) is arranged in a closely compressed configuration wherein each trash bag is positioned entirely within the preceding trash bag with no air in between.

In accordance with the embodiments described herein, the trash bags are constructed in such a manner that they are conjoined in a series, with each bag being removably attached to the adjacent bag by means of a perforation line. The perforation line is designed to be sufficiently sturdy to maintain the bags attached to each other under normal handling conditions, but also to allow for easy separation when an individual bag is needed. Perforated belts (neck) or separation zones are provided for individual trash bag removal, and a shared header works with the bag retention system to secure and seal the trash bag assembly inside the trash receptacle.

Each individual trash bag can contain a drawstring right below the perforated belt for easy sealing and carrying. The drawstring is constructed of durable, pliable material that allows for ease of closure by drawing the string closed, effectively cinching the bag's opening to secure its contents. The incorporation of the drawstring is such that it is threaded through a series of apertures or loops that are an integral part of the bag's design at the open top end. These apertures or loops ensure the drawstring remains attached to the bag and provides a means for the drawstring to slide freely when being tightened. The open top end of the bag may be reinforced with a thicker material or a dual layer of the same material to provide additional support for the drawstring. This reinforcement prevents tearing or damage to the bag when the drawstring is pulled to close the bag and when the bag is lifted or carried by the drawstring. The drawstring can be easily tied, creating a knot that keeps the top of the bag securely closed, which helps in the containment of waste and odor and allows for easier transportation and disposal. The drawstring can be tucked into the interior of the bag or wrapped around the exterior of the closed top end, after tying, to maintain a neat and tidy appearance. The color of the drawstring may vary and can be selected to contrast with the color of the bag to make it more visible, or it can match the bag to create a uniform look.

In embodiments, the bag retention system further includes a liner ring positioned at the upper edge of the trash receptacle, the liner ring being configured to: securely hold the trash bag assembly in place during use, seal the air between the trash bag assembly and the interior of the trash receptacle to maintain optimal airflow control, and cover the exposed exterior segment of the trash bag assembly situated outside the trash receptacle to enhance the aesthetic appearance of the system.

The individual bags may be fabricated from various materials commonly used for waste containment, such as polyethylene, polypropylene, or biodegradable materials, and can be tailored to different sizes and strengths to suit specific requirements. The versatility in material choice allows for customization based on environmental considerations or specific user preferences.

The receptacle or container, as detailed in this description, is characterized by a rigid structure which provides durability and stability to the overall assembly. The rigid structure is specifically designed to withstand various environmental conditions, including but not limited to temperature extremes, humidity, and physical impacts that could occur during the handling and transportation of the receptacle. The rigid structure itself is devised from materials known for their strength and resilience. Examples of such materials include, but are not limited to, metals such as steel or aluminum, rigid plastics like high-density polyethylene (HDPE), or composites that amalgamate fibers such as carbon or glass with a resin matrix to enhance rigidity and strength characteristics. The selection of material will depend on factors like the required strength to weight ratio, cost considerations, compatibility with the receptacle's contents, and the environment in which the receptacle will be used. In terms of construction, the rigid structure may incorporate various design features to bolster its functionality. These can include reinforcing ribs or frames, which serve to enhance the overall strength and help to maintain the receptacle's shape under load. The structure may also include integrated components such as handles, latching mechanisms, or mounting points, which are specifically designed to remain functional and robust in relation to the rigid nature of the receptacle.

An optional compression system can be provided in the receptacle that includes a blow fan integrated into the trash receptacle, the blow fan operable to expel air trapped between the trash bag assembly and the inner walls of the trash receptacle during trash bag installation, thus ensure the trash bag assembly conforms closely to the trash receptacle's interior, optimizing its capacity and stability. The optional controllable airflow system includes:
(i) multiple air inlets positioned on the interior of the trash receptacle bottom for drawing air from the trash receptacle's interior,
(ii) an air compartment connected to the blow fan, the air compartment configured to channel air from the air inlets to the blow fan,
(iii) an air outlet positioned on the exterior of the trash receptacle, the air outlet operable to discharge air from the trash receptacle, and
(iv) a one-way valve operatively located at either the input or output of the blow fan, the one-way valve allowing air to flow only in the direction of the air outlet,

The airflow system works in coordination with the blow fan to remove trapped air from the interior of the trash receptacle and maintain the trash bag in close adherence to the trash receptacle's interior walls, thereby improving bag placement stability and optimizing effective capacity.

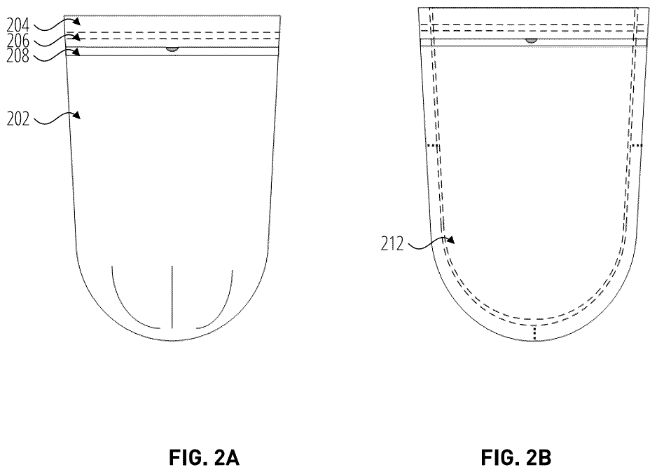

FIGS. 2A-2B illustrate exemplary nested trash bags 202, one inside the other. Each of these trash bags 202 also has an open top end, through which waste materials can be deposited, as well as a closed bottom end that serves to contain the trash. To address the often cumbersome task of changing bags, this configuration allows for an easy and hygienic replacement process. Each bag 202 has a drawstring 208, a neck 206 and a header 204. The bags 202 are grouped inside each other, i.e., the innermost bag is inside of the next bag, and so on. The trash bags within the stack are removably attached to the header 204. These connections can be implemented through a variety of means such as adhesive strips, mechanical snaps, or detachable perforations. The attachments are designed in such a way that, when the innermost trash bag is filled and subsequently removed from the receptacle, it automatically separates from the next bag in the stack. Upon the removal of a filled bag, the subsequent trash bag 202 is thus presented and poised for immediate use. The detachment and presentation of the next bag in the stack are facilitated without the need for the user to manually unfold or separate an individual bag from a roll or stack, thus providing an efficient and seamless transition from one bag to the next.

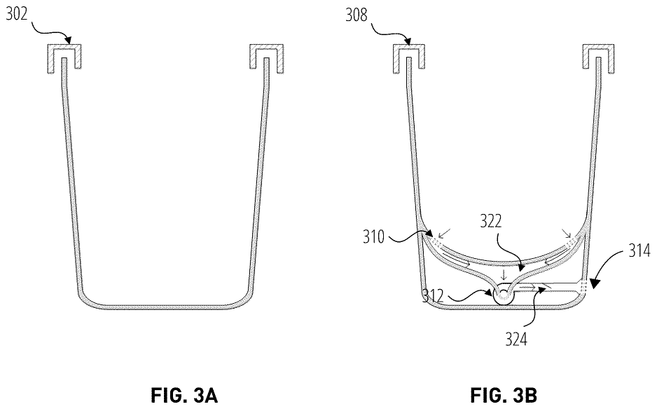

FIGS. 3A-3B illustrate exemplary system to form a group of bags in sequence for use through a liner ring with a fan. In FIG. 3A, a liner ring 302 is positioned at the top of the system. FIG. 3B shows a liner ring 308 over the system where an air inlet 310 is positioned at a curved bottom. A blow fan 312 forces air flow from the receptacle interior to the air compartment 322 via air inlets 310, then to the air outlet 314 via a one-way valve 324.

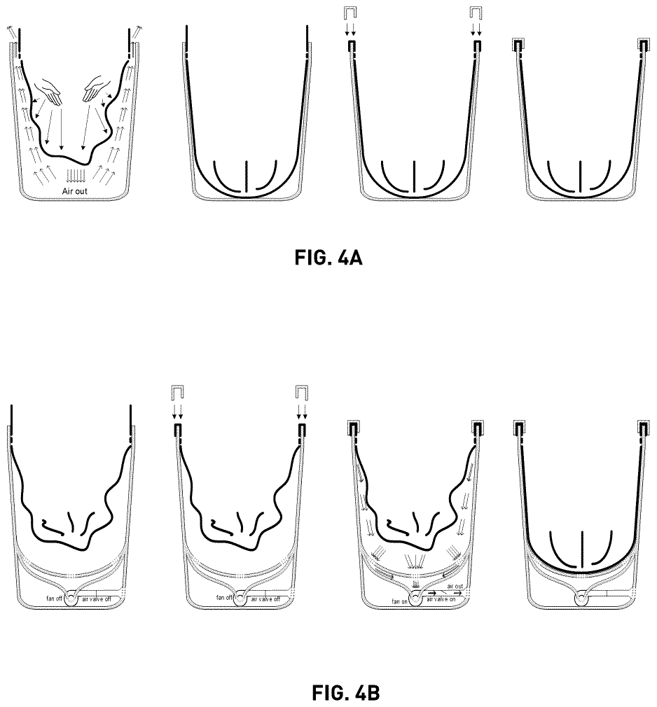

FIGS. 4A-4B illustrates one embodiment with manual and with powered air assisted trash bag deployment. As shown in FIG. 4A, a bag assembly is inserted into the system, air is removed by hand operation and the bag assembly is flushed against the wall of the system. The liner ring is inserted thereafter to secure the bag assembly. FIG. 4B shows a fan-based version of FIG. 4A where a bag assembly is inserted into the system, air is removed by motor or fan operation and the bag assembly is flushed against the wall of the system. The liner ring is inserted thereafter to secure the bag assembly.

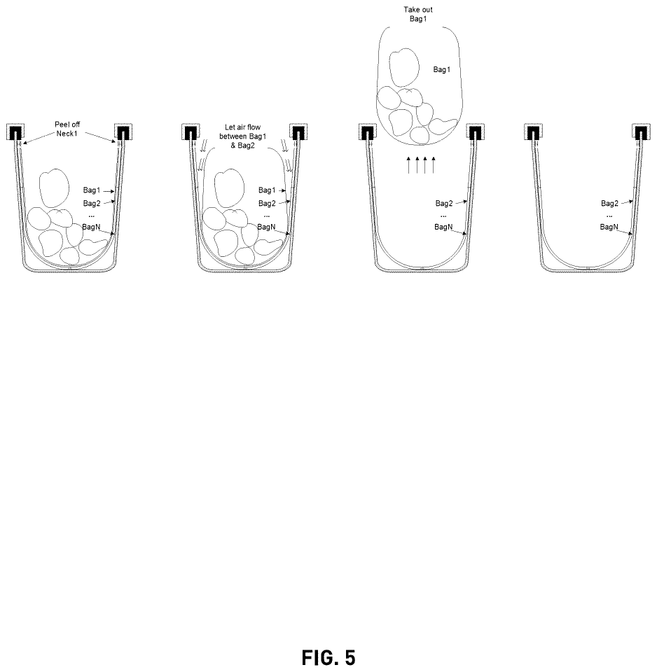

FIG. 5 illustrates an exemplary removal of a trash bag in accordance with the invention. As shown therein, the neck of the bag is peeled, allowing air to flow into the space between two adjacent bags. The innermost bag that receives trash can then be removed, leaving the adjacent bags surrounding the innermost bag in the system for receiving future trash.

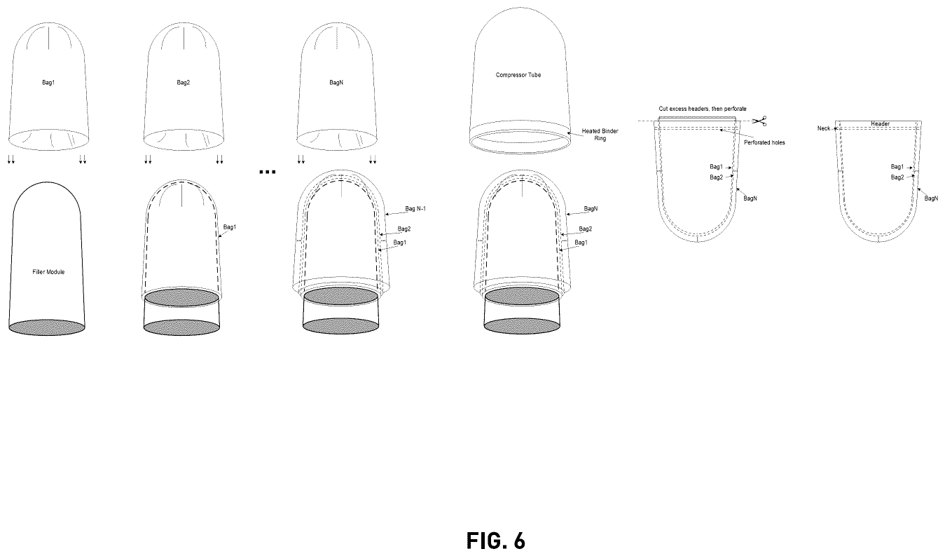

FIG. 6 illustrates an exemplary system for forming a group of nested trash bags. The first bag is placed over a filler module. Then additional bags are fitted over the prior bags. After the last bag has been fitted over the module/bags, a compressor tube is placed as a last structure over all bags with a heated binder ring. Excess headers are trimmed, and perforated holes are formed near the top of the bags.

The individual trash bags of the trash bag assembly can be identical, or inner trash bags are slightly smaller than outer trash bags, depending on the manufacturing process. The placing of the bag retention system (liner ring) can at the same time activate the blow fan and the one-way valve. The filler module can be conical or cuboid in shape.

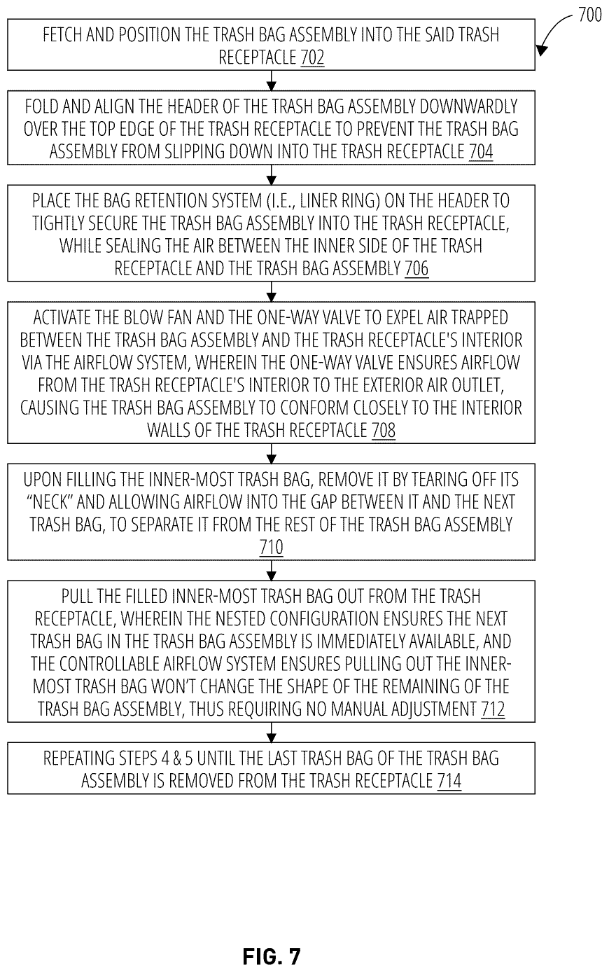

Next, a method for installing and removing the trash bag assembly in the trash management system is shown in FIG. 7. The method includes fetching and positioning the trash bag assembly into the said trash receptacle; folding and aligning the header of the trash bag assembly downwardly over the top edge of the trash receptacle to prevent the trash bag assembly from slipping down into the trash receptacle; placing the bag retention system (i.e., liner ring) on the header to tightly secure the trash bag assembly into the trash receptacle, while sealing the air between the inner side of the trash receptacle and the trash bag assembly; activating the blow fan and the one-way valve to expel air trapped between the trash bag assembly and the trash receptacle's interior via the airflow system, wherein the one-way valve ensures airflow from the trash receptacle's interior to the exterior air outlet, causing the trash bag assembly to conform closely to the interior walls of the trash receptacle. Upon filling the innermost trash bag, the process includes removing it by tearing off its “neck” and allowing airflow into the gap between it and the next trash bag, to separate it from the rest of the trash bag assembly; pulling the filled innermost trash bag out from the trash receptacle, wherein the nested configuration ensures the next trash bag in the trash bag assembly is immediately available, and the controllable airflow system ensures pulling out the innermost trash bag won't change the shape of the remaining of the trash bag assembly, thus requiring no manual adjustment; and repeating until the last trash bag of the trash bag assembly is removed from the trash receptacle.

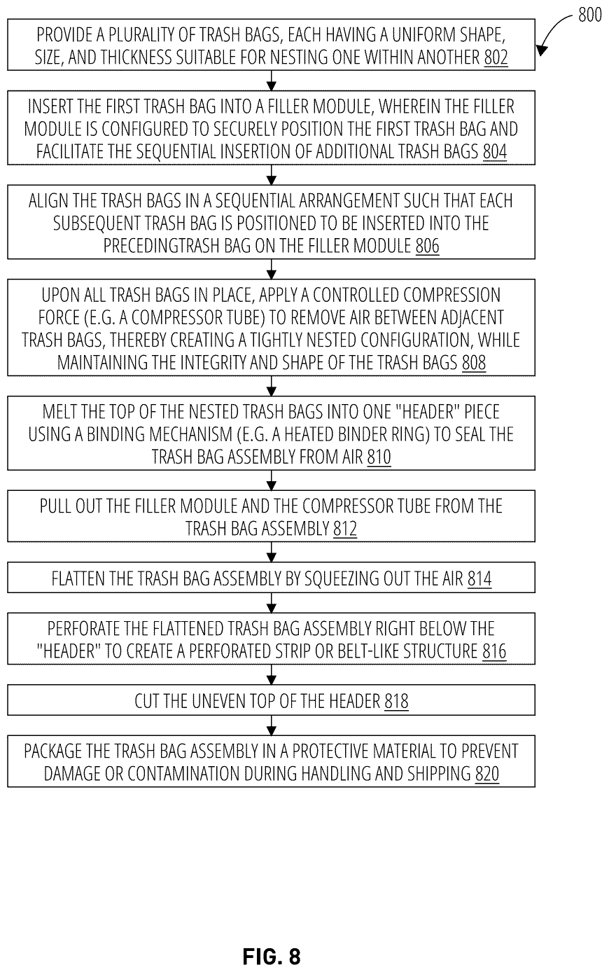

FIG. 7 illustrates the method for removing a filled trash bag from an embodiment while FIG. 8 illustrates the method for manufacturing the trash bag assembly. In block 702, routine 700 fetches and positions the trash bag assembly into the trash receptacle. In block 704, routine 700 folds and aligns the header of the trash bag assembly downwardly over the top edge of the trash receptacle to prevent the trash bag assembly from slipping down into the trash receptacle. In block 706, routine 700 places the bag retention system (i.e., liner ring) on the header to tightly secure the trash bag assembly into the trash receptacle, while sealing the air between the inner side of the trash receptacle and the trash bag assembly. In block 708, routine 700 activates the blow fan and the one-way valve to expel air trapped between the trash bag assembly and the trash receptacle's interior via the airflow system, wherein the one-way valve ensures airflow from the trash receptacle's interior to the exterior air outlet, causing the trash bag assembly to conform closely to the interior walls of the trash receptacle. In block 710, routine 700 upon filling the innermost trash bag, removes it by tearing off its “neck” and allowing airflow into the gap between it and the next trash bag, to separate it from the rest of the trash bag assembly. In block 712, routine 700 pulls the filled innermost trash bag out from the trash receptacle, wherein the nested configuration ensures the next trash bag in the trash bag assembly is immediately available, and the controllable airflow system ensures pulling out the innermost trash bag won't change the shape of the remaining of the trash bag assembly, thus requiring no manual adjustment. In block 714, routine 700 repeating steps 4 & 5 until the last trash bag of the trash bag assembly is removed from the trash receptacle.

In block 802, routine 800 provides a plurality of trash bags, each having a uniform shape, size, and thickness suitable for nesting one within another. In block 804, routine 800 inserts the first trash bag into a filler module, wherein the filler module is configured to securely position the first trash bag and facilitate the sequential insertion of additional trash bags. In block 806, routine 800 aligns the trash bags in a sequential arrangement such that each subsequent trash bag is positioned to be inserted into the preceding trash bag on the filler module. In block 808, routine 800 upon all trash bags in place, apply a controlled compression force (e.g. a compressor tube) to remove air between adjacent trash bags, thereby creating a tightly nested configuration, while maintaining the integrity and shape of the trash bags. In block 810, routine 800 melts the top of the nested trash bags into one “header” piece using a binding mechanism (e.g. a heated binder ring) to seal the trash bag assembly from the air. In block 812, routine 800 pulls out the filler module and the compressor tube from the trash bag assembly. In block 814, routine 800 flattens the trash bag assembly by squeezing out the air. In block 816, routine 800 perforates the flattened trash bag assembly right below the “header” to create a perforated strip or belt-like structure. In block 818, routine 800 cuts the uneven top of the header. In block 820, routine 800 packages the trash bag assembly in a protective material to prevent damage or contamination during handling and shipping.

In accordance with one implementation, the trash bag assembly includes a compressor component that is especially designed to effectively remove the trapped air that often becomes an issue when positioning a trash bag within a receptacle. The trapped air between a trash bag and the inner walls of the receptacle can make the placement of the bag cumbersome, can lead to inefficient use of the volume within the receptacle, and can cause the bag to bulge awkwardly, making subsequent removal of the filled bag difficult. To address this problem, the compressor is designed in a way that it can expel this excess air to ensure the trash bag fits snugly against the inner surfaces of the receptacle.

The compressor is further configured with control electronics that enables the regulation of airflow, such that air is only permitted to flow in a single direction, specifically from the interior space of the trash receptacle toward the exterior. This is crucial for preventing outside air from re-entering the space between the trash bag and the receptacle, which would otherwise defeat the purpose of expelling the air in the first place. Such re-entry of air could potentially inflate the bag away from the walls of the receptacle and reintroduce the original problem the compressor is meant to solve.

The compressor itself may be integrated into the receptacle or container as a built-in feature or alternatively, be designed as an attachable unit that can be affixed to various types of receptacles. It may be powered by different sources such as electricity, battery, or even manual hand pumping, depending on the design and intended convenience for the user. The essential characteristic of the compressor is its ability to control airflow direction and eliminate the excess air without requiring physical manipulation of the trash bag by the user, which could be both inconvenient and unsanitary.

The use of such a compressor within the context of a trash receptacle offers several advantages, including improved user experience, enhanced functionality of the trash bag, and overall improved hygiene by minimizing the need for direct contact with the trash bag during and after placement. This inventive feature therefore represents a substantial improvement over conventional trash receptacle and bag systems.

One implementation provides an innovative trash bag assembly designed to enhance the utility and convenience of refuse handling in a variety of environments. The assembly features a series of trash bags, each of which is meticulously positioned within the confines of the preceding trash bag without any presence of air between them, thus creating a compact and efficient stacking system.

A shared header further complements the assembly, its primary function being to couple with the bag retention system integral to the trash receptacle. The shared header is designed to ensure that the assembly is securely anchored within the receptacle, remaining in an optimal position for user access. This header also plays a crucial role in sealing the ensemble, which not only aids in preserving the stacked arrangement but additionally assists in preventing the ingress of unwanted materials into the unused bags.

Overall, the described trash bag assembly offers a pragmatic and resourceful solution for streamlining trash collection and disposal, characterized by ease of use, enhanced efficiency, and a heightened focus on sanitary waste management practices.

The bag retention system of one implementation includes a novel liner ring which is designed to rest at the upper edge of the trash receptacle. This liner ring plays a pivotal role in the overall functionality of the system, being crafted with careful consideration to provide multiple benefits and enhancements over traditional systems.

Furthermore, the liner ring includes a unique sealing feature which serves to seal the air between the trash bag assembly and the interior of the trash receptacle. This sealing action is not merely to prevent the escape of odors but is meticulously designed to maintain optimal airflow control within the receptacle. The control of airflow is critical, as it directly influences the ease of inserting and removing the bag, the prevention of “vacuum effect” or “bag puffing,” and the general handling of the bag during waste disposal. The sealing aspect of the liner ring can be realized through several mechanisms including, but not limited to, a continuous or interrupted gasket, a series of sealing flaps, or an interference fit between the liner ring and the bag assembly.

Lastly, important consideration has been given to the aesthetic appearance of the system. The liner ring is crafted to cover the exposed exterior segment of the trash bag assembly that traditionally would hang over the lip of a trash receptacle, thus creating an unsightly appearance. By extending over this segment, the liner ring provides a clean and tidy look to the receptacle, which is particularly advantageous in spaces where the visual presentation is of importance. The liner ring could be designed with a variety of finishes, colors, or textures to either blend in with the receptacle or perhaps to provide a pleasing contrast, depending on the designer's intent.

When a user places a new trash bag into the trash receptacle, typically, air can become entrapped between the bag and the receptacle which may cause the bag to puff up and not sit properly within the receptacle. This air makes it difficult to fit the bag snugly against the walls of the trash receptacle and could potentially create undesirable air pockets that decrease the effective volume of the trash bag for waste disposal. Furthermore, trapped air may cause the bag to move or shift out of place during use.

The blow fan is operable to mitigate this issue by expelling the trapped air. Once the trash bag is positioned within the trash receptacle, the blow fan can be activated. Upon activation, the blow fan draws air from within the trash receptacle and forces the air outward. This action reduces the air pressure between the trash bag and the inner walls of the receptacle, allowing the trash bag to collapse against the walls and thus, seating it properly within the receptacle.

The blow fan may be powered electrically through a connection to an external power source or may incorporate an internal power source such as batteries. Additionally, the blow fan may be activated by a switch or sensor. A sensor could detect the presence of a trash bag and automatically activate the blow fan for a predetermined amount of time or until the sensor determines that the air has been sufficiently expelled.

The inclusion of the compressor with the blow fan adds functionality to the trash receptacle, making the process of changing trash bags simpler and more efficient for the user. Moreover, the blow fan can be designed to operate quietly so as not to cause disruption in a domestic or commercial environment where the trash receptacle is used.

One implementation thereby provides an improved trash receptacle that simplifies the process of bag installation and ensures that the trash bag fits securely within the receptacle, increasing the efficiency of waste collection and the overall user experience.

One implementation pertains to a trash receptacle with an enhanced airflow system designed to facilitate the secure placement of trash bags within the receptacle and improve their capacity utilization. The receptacle is characterized by a system that allows for the controlled removal of air trapped between the trash bag and the inner walls of the receptacle, thereby ensuring the bag's stability and maximizing the use of its volume.

The trash receptacle incorporates a series of air inlets strategically located at the bottom of its interior. These inlets are designed to draw air from within the receptacle. The airflow system is such that it pulls the air towards an air compartment. This compartment is directly connected to a blow fan, whose operation is central to the system's function.

Critical to the operation of the airflow system is the inclusion of a one-way valve. This valve can be located at the input or the output of the blow fan, depending on the specific design requirements. The key function of the one-way valve is to ensure unidirectional airflow, thereby preventing any backflow of air that could disrupt the intended operation and efficiency of the system.

In the disclosed method, an individual or automated system initially fetches a trash bag assembly, designed for use within a particular trash management system. The assembly typically comprises multiple trash bags that are interconnected, often through a perforated seam that allows for the detachment of each bag individually.

A header is provided at the top of the trash bag assembly, which is folded and aligned over the top edge of the trash receptacle. This folding and aligning operation is crucial as it prevents the trash bag assembly from slipping into the trash receptacle, which can occur especially when trash is placed into the bag and applies downward pressure.

Once the header is placed in position, a bag retention system is placed onto the header. The purpose of the bag retention system is to secure the trash bag assembly onto the trash receptacle. Additionally, an effective seal is created between the inner side of the trash receptacle and the trash bag assembly. This seal is vital for both the prevention of contamination from spillage and for optimizing the performance of the subsequent steps in the method.

Upon the filling of an innermost trash bag, that is, the bag which is currently open and collecting trash, the individual or automated system tears off the bag neck. The bag neck is designed to tear in a controlled manner, and this action allows airflow into the gap between the filled bag and the next trash bag. This part of the process serves to separate the filled bag from the rest of the trash bag assembly, allowing for its removal.

This method streamlines the process of trash management and replacement of bags within a trash receptacle, ensuring a more hygienic environment, reducing the likelihood of contamination and spillage, and optimizing the capacity utilization of each trash bag within the receptacle.

The initial step in the manufacturing sequence includes inserting the first trash bag into a specifically designed filler module. This filler module serves an essential role in the manufacturing process as it is engineered to securely position the initial trash bag. Furthermore, it aids in the sequential insertion of additional trash bags, thereby streamlining the manufacturing process.

Once all the trash bags are properly aligned and in place, a controlled compression force is applied to the arrangement. This step is crucial as it serves to remove any air trapped between adjacent trash bags, thereby creating a tightly nested configuration of bags. Notably, the compression force is carefully modulated to ensure that while the air is expelled, the integrity and shape of the trash bags are preserved.

Following the compression step, the top sections of the nested trash bags are subjected to a melting process. This is accomplished using a binding mechanism that effectively melts the top of the nested bags into a single “header” piece. The result is a seal that prevents ingress of air into the trash bag assembly, ensuring that the nested configuration is maintained.

Next, the assembly process necessitates the removal of the filler module as well as the compressor tube that facilitated the insertion and compression of the trash bags. This withdrawal leaves the trash bag assembly in a secure nested state.

In further preparation for packaging and handling, the trash bag assembly is flattened by an action that squeezes out any residual air. This flattening process assists in minimizing the volume of the assembly for easier packaging, storage, and transport.

The manufacturing process also includes a perforating action applied just below the seamlessly fused header. This creates a perforated strip or belt-like structure that will later enable the end user to detach individual trash bags from the assembly with ease.

To ensure the product is aesthetically pleasing and uniform, the uneven top of the now-sealed header is cut. This cutting step provides a clean and even edge to the product.

Finally, the completed trash bag assembly is packaged in protective material. The choice of this material is imperative since it prevents damage or contamination during the handling and shipping stages. This protective packaging assures that the final product reaches the consumer in optimal condition, ready for use in a variety of trash management settings.

The method begins with the provision of a receptacle that features an open top end and a closed bottom end. The open top end allows for the placement and removal of bags, while the closed bottom end ensures containment of waste within the receptacle.

Once the nested trash bags are placed and appropriately attached within the receptacle, the innermost trash bag can be used for the deposit of waste. This innermost trash bag is easily accessible from the open top end of the receptacle and is ready for use immediately after the prior bag's removal.

The method of one implementation thus provides an efficient, convenient solution for managing trash bags in various settings, negating the mundane task of trash bag replacement and allowing users to maintain cleanliness with minimal interruption to their activities.

The innovation further comprises a mechanism designed to secure the open top end of the innermost trash bag from within a stack of trash bags to the open top end of the receptacle. This mechanism ensures that the innermost trash bag is maintained in an open position, ready to receive refuse. The mechanism prevents the innermost bag from collapsing or slipping inside the receptacle which facilitates easy disposal of waste without the need to manually adjust or hold the bag open.

In one embodiment, the securing mechanism may include a series of clips, adhesive strips, or a continuous ring that is affixed around the periphery of the open top end of the receptacle. The clips or adhesive strips grab onto a section of the open top end of the innermost bag when the bag is placed over the open top end of the receptacle and stretched across to ensure it fits snugly. This configuration provides for a temporary yet secure connection that can easily be released when the bag is full and needs to be replaced. The continuous ring, on the other hand, may feature an elastic, spring-like, or otherwise expandable/collapsible design, allowing the top edge of the trash bag to be tucked under the ring, holding the bag in place by applying a consistent outward pressure against the interior surface of the receptacle.

Additionally, the mechanism is designed in such a way that it does not interfere with the compactness of the stack of trash bags housed within the receptacle. The stackability of the bags is preserved, allowing the user to replace the innermost bag with the next one in the stack easily and quickly once the currently secured bag is removed. This streamlined process ensures that there is no significant interruption in the use of the receptacle for waste disposal, as a new bag is always immediately ready for use upon removal of the filled one.

It should be noted that the materials used for the securing mechanism are chosen for their durability, ease of cleaning, and resistance to the wear and tear of daily use. They can withstand the rigors of refuse materials and are compatible with the materials used for trash bags, ensuring a long-lasting and effective securing system. This integration of the securing mechanism into the trash receptacle design underscores the innovative approach to enhancing waste management processes within both residential and commercial settings.

In one implementation, the configuration of the innermost trash bag is such that it comprises a drawstring incorporated at the open top end. The drawstring is designed to facilitate an easy and efficient removal process for the user. The user can remove the innermost trash bag from a receptacle or a receptacle by simply pulling on the drawstring. The drawstring, when pulled, constricts the opening of the trash bag, effectively sealing the contents inside and creating a handle for the user to hold and lift the bag with ease.

The addition of the drawstring to the trash bag design enhances user experience by providing a practical and hygienic method of disposal. It allows a person to remove a full bag without directly touching the trash or the interior surface of the receptacle, thus maintaining cleanliness and reducing potential contamination.

The aforementioned detailed description exemplifies one implementation's operation and serves to further illustrate its benefits in waste management practices. It also provides a clear understanding of the functional advantages the drawstring brings to conventional trash bags, adding to the inherent innovative nature of one implementation.

Moreover, the placement of the perforations is carefully determined to ensure that, when an individual trash bag is torn from the adjacent bag, it maintains its structural integrity and functionality. This includes consideration for the placement of any seams or additional features the trash bag may have, like drawstrings or handles. The perforations are aligned in such a way that they do not weaken these features or the bag's bottom, which is critical for preventing leaks and breakages.

Lastly, it should be noted that, while this description specifically addresses trash bags, the same method and orientation of perforations can be extended to similar bag-like receptacles designed for holding various types of waste or materials, thus exhibiting the broader utility of one implementation.

The bags may be manufactured from a variety of materials, including but not limited to, plastics, biodegradable materials, or composites thereof. The choice of material may affect the type of adhesive used, as different materials will interact with adhesives in different ways. For example, an adhesive that works well with a plastic bag may not be suitable for a biodegradable bag made from organic materials.

Upon deciding to remove a bag from the stack, the user can simply apply a pulling force to the desired bag. This force needs to overcome the adhesive bond, causing the bags to separate. Importantly, the separation occurs without tearing the bags or leaving them with areas of compromised structural integrity, thus ensuring that each bag maintains its full functionality after detachment.

Overall, the adhesive application method offers an effective solution to creating a user-friendly, efficient method for storing and dispensing trash bags. The described approach allows for a seamless experience where the bags can be kept in a compact and orderly fashion and separated with ease when needed, resulting in a balance between convenience, functionality, and manufacturing efficiency.

In one embodiment, the handles are made from a high-strength polymer that can withstand repetitive use and resist wear and tear due to heavy loads or harsh environmental conditions. The handles may be reinforced with a metal insert or coating to further increase their strength and durability. Alternatively, the handles could be made entirely of metal, or other suitable materials depending on the specific requirements of the receptacle's application.

The handles may be either permanently affixed to the receptacle or detachable/adjustable to suit various carrying preferences and to accommodate storage or space constraints when the receptacle is not in use. This versatility in handle configuration may also allow the receptacle to be adaptable to different uses, whether it needs to be carried by hand or attached to other equipment for transport.

In addition, one implementation encompasses the possibility of including multiple sets of handles. For instance, a first set of handles can be placed on opposing sides of the receptacle for carrying by a single individual, and a second set may be located at strategic positions meant for two-person lift situations. This dual-handle configuration significantly enhances the usability of the receptacle for different load requirements and user scenarios.

The above-described receptacle, specifically augmented with handles for carrying, thus represents an improved one implementation with significant considerations made for functionality, durability, usability, and user comfort. It is evident that through the careful integration of handles into the design of the receptacle, one implementation offers an advantageous means for handling and transporting items safely and efficiently.

Biodegradable materials are those which can be broken down and decomposed by natural biological processes, typically involving the action of microorganisms such as bacteria and fungi over a period of time. Biodegradable materials can include but are not limited to polymers that are designed to decompose in the environment under natural conditions. Such biodegradable polymers can be produced from renewable resources, including plant-based materials like corn starch, cellulose, or other polysaccharides. They can also be synthesized from petrochemical resources with chemical structures that are amendable to biodegradation.

Further elaboration can be made with respect to the specific types of biodegradable materials chosen for the bags. For instance, if a compostable material is used, the bags may be certified to break down in a composting environment, aligning with international standards such as ASTM D6400 or EN 13432 for compostable plastics. Additionally, materials might be chosen to optimize the rate of degradation in different contexts, such as in industrial composting facilities, home composting setups, or in natural environments with varying conditions of humidity, temperature, and microbial activity.

In summary, the selection of biodegradable material for trash bags as set forth herein promotes an environmentally conscientious approach to waste management. Through careful material selection and product design, the resultant trash bags address ecological concerns by providing a waste containment solution that minimizes long-term environmental impacts.

The markings can be in various forms such as lines, numbers, symbols, or any other type of indicia that can effectively communicate the quantity of remaining trash bags to the user. The purpose of these markings is to provide a straightforward and unambiguous way for the user to be aware of how many trash bags are left, enabling the user to plan for replacement of the bags and maintain an efficient trash disposal process.

This system integrated into the trash receptacle may be implemented in various ways. For example, each marking may correspond to a single trash bag, such that as each trash bag is removed for use, the marking that corresponds to that bag is revealed or otherwise becomes the new visible or tactile indicator of the remaining quantity. Alternatively, if the bags are dispensed from the receptacle in a manner that sequentially exposes each marking, the markings may provide a countdown-like indication.

The operational dynamics of the system ensure that the indication of the remaining bags is updated automatically as each bag is removed from the receptacle. This may be facilitated by a passive mechanical system requiring no user input apart from the usual action of removing a bag or, in some embodiments, may be aided by electronic or smart technology that detects the removal of a bag and updates a display correspondingly.

In some embodiments, the markings indicating the remaining bags may also serve as a guide for refilling the receptacle. When no bags are left and the markings indicate the need to refill, users can easily restock the receptacle to its full capacity by ensuring they add enough bags to reach the initial indicator marking.

The inventive concept provides an improved trash bag receptacle that accounts for the convenience and efficiency of monitoring the supply of trash bags, thereby enhancing user experience and reducing the chance of being inconvenienced by unexpected depletion of the bags. This proactive aspect of the receptacle's design transforms a simple trash disposal system into a more intelligent and user-friendly utility.

Additionally, the dispensing mechanism might employ a frictional engagement feature, where the bags have a certain level of adherence to each other, ensuring that when one bag is pulled, the subsequent bag is positioned for easy access and dispensing. This frictional engagement may be achieved through textured surfaces on the mechanism or the bags themselves.

The receptacle and dispensing mechanism are designed such that refilling the receptacle with a new supply of trash bags is both simple and intuitive. An access point, such as a lid or a panel, may be provided on the receptacle for this purpose. Once the stack or roll of bags is loaded into the receptacle, the dispensing mechanism is configured to commence the operation without the need for additional setup or adjustment by the user.

Moreover, the receptacle may be constructed from materials suitable to withstand the typical conditions associated with waste disposal, such as moisture, varied temperatures, and frequent use. The design of the receptacle also lends itself to be space-efficient and aesthetically pleasing, enabling it to be placed in various settings like kitchens, bathrooms, offices, or outdoor areas near trash collection points.

It is noted that, in this document, relational terms such as “first” and “second,” and the like, may be used solely to distinguish one entity or action from another entity or action without necessarily requiring or implying any actual such relationship or order between such entities or actions. Also, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Without further limitation, an element defined by the phrase “comprising an . . . ” does not exclude the presence of other identical elements in a process, method, article, or apparatus that comprises the element.

The above description is only exemplary of the invention, and is intended to enable those skilled in the art to understand and implement the invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A nested trash bag system comprising:
a receptacle including:
a container having an open top end and a closed bottom end; and
a bag retention system configured to maintain a trash bag assembly in a predetermined position; and
a trash bag assembly comprising a plurality of trash bags nested within the receptacle, wherein:
each trash bag is proximal to an adjacent trash bag with a predetermined air gap therebetween;
each trash bag is removably attached to the bag assembly; and
removal of an inner trash bag from the receptacle automatically positions a subsequent trash bag for use.

2. The nested trash bag system of claim 1, wherein the bag retention system comprises a liner ring positioned at an upper edge of the receptacle, the liner ring being configured to:
secure the trash bag assembly in place during use;
seal air between the trash bag assembly and the interior of the receptacle; and
cover the exposed exterior segment of the trash bag assembly situated outside the receptacle to enhance the aesthetic appearance of the system.

3. The nested trash bag system of claim 1, wherein the receptacle comprises a blow fan and a controllable airflow system, the airflow system including:
multiple air inlets positioned at the interior bottom of the receptacle to draw air from the receptacle's interior;
an air compartment connected to the blow fan, the air compartment configured to channel air from the air inlets to the blow fan;
an air outlet positioned on the exterior of the receptacle, the air outlet operable to discharge air from the receptacle; and
a one-way valve positioned at either the input or output of the blow fan, the one-way valve allowing air to flow exclusively in the direction of the air outlet,
wherein the airflow system and blow fan operate together to remove trapped air between the trash bag assembly and the receptacle's interior walls, thereby improving bag placement stability and optimizing the effective capacity of the system.

4. The nested trash bag system of claim 1, wherein the trash bag assembly further comprises:
a header coupled to the bag retention system to secure and seal the trash bag assembly within the receptacle; and
individual trash bags connected to the header via perforated belts, perforated lines, or separation zones to facilitate easy removal.

5. The nested trash bag system of claim 1, wherein each trash bag includes a drawstring at its open top end.

6. The nested trash bag system of claim 1, wherein the receptacle includes a lid configured to cover the open top end.

7. The nested trash bag system of claim 1, wherein the receptacle includes one or more carrying handles.

8. The nested trash bag system of claim 1, wherein the receptacle includes markings to indicate the number of remaining trash bags.

9. The nested trash bag system of claim 1, wherein the receptacle is configured to dispense the trash bags one at a time.

10. A method for manufacturing a trash bag assembly in a trash management system, comprising:
providing a plurality of trash bags, wherein the trash bag has a uniform shape, size, and thickness nested one within another;
inserting the first trash bag into a filler module, wherein the filler module is configured to securely position the first trash bag and facilitate the sequential insertion of additional trash bags;
aligning the trash bags in a sequential arrangement such that each subsequent trash bag is positioned to be inserted into the preceding trash bag on a filler module;
upon all trash bags in place, applying a controlled compression force to remove air between adjacent trash bags to create a nested configuration while maintaining an integrity and a shape of the trash bags;
melting the top of the nested trash bags into a header piece using a binding mechanism to seal the trash bag assembly from air;
pulling out the filler module from the trash bag assembly;
flattening the trash bag assembly by squeezing out the air;
perforating the flattened trash bag assembly right below the header to create a perforated strip or belt-like structure;
trimming a top of the header; and
packaging the trash bag assembly in a protective material to prevent damage or contamination during handling and shipping.

11. A method of using a nested trash bag system, the method comprising:
providing a receptacle having an open top end and a closed bottom end;
inserting a trash bag assembly;
folding and aligning the header of the trash bag assembly downwardly over the top edge of the trash receptacle to prevent the trash bag assembly from slipping down into the trash receptacle;
placing the bag retention system (i.e., liner ring) on the header to tightly secure the trash bag assembly into the trash receptacle, while sealing the air between the inner side of the trash receptacle and the trash bag assembly;
expel air trapped between the trash bag assembly and the trash receptacle's interior to make the trash bag assembly conform closely to the interior walls of the trash receptacle;
using an innermost trash bag; and
removing the innermost trash bag from the receptacle, thereby automatically positioning a subsequent trash bag for use.

12. The method of claim 11, wherein removing the innermost trash bag comprises pulling a drawstring at the open top end of the innermost trash bag.

13. The method of claim 11, further comprising indicating the number of remaining trash bags using markings on the receptacle.
